(19) United States
(12) Patent Application Publication
(10) Pub. No.: US 2011/0311797 A1
(43) Pub. Date: Dec. 22, 2011

(54) TPO ROOFING MEMBRANE WITH ADHESIVE READY BOTTOM LAYER

(75) Inventors: David Worthen, Wilton, NH (US); Steven Zidek, Nashua, NH (US)

(73) Assignee: Worthen Industries, Nashua, NH (US)

(21) Appl. No.: 13/155,816

(22) Filed: Jun. 8, 2011

Related U.S. Application Data
(60) Provisional application No. 61/355,342, filed on Jun. 16, 2010.

(51) Int. Cl. B32B 27/32; B05D 7/04; B32B 27/08; B31B 1/60

(52) U.S. Cl. 428/220; 156/60; 427/412.3; 428/500; 428/516; 428/334

(57) ABSTRACT

A method for producing a TPO membrane includes providing on at least a base or lower surface of the TPO membrane a primer or tie layer having a polar component or element and which allows the TPO membrane to adhere to a substrate using a water based or a low or no VOC containing adhesive. In one embodiment, the tie layer is added to an existing TPO membrane while in another embodiment, the tie layer is co-extruded with the TPO at the time the TPO membrane is manufactured. In the preferred embodiment, the tie layer is an E-VA-MAH based layer.

### CROSS-REFERENCE TO RELATED APPLICATIONS

This application claims priority from U.S. Provisional Patent Application No. 61/355,342, titled “TPO Roofing Membrane With Adhesive Ready Bottom Layer” filed Jun. 16, 2010 and incorporated fully herein by reference.

### TECHNICAL FIELD

The present invention relates to polymer membranes and more particularly, to thermoplastic polyolefin (TPO) roofing membranes having a tie or bottom layer predisposed to be adhered to an underlayment with water based or low VOC adhesives.

### BACKGROUND INFORMATION

A relatively recent advancement in the polymer technology industry is now gaining widespread use in the roofing industry in the form of thermoplastic polyolefin (TPO) membranes. An example of such TPO membranes is the Dow Tiempo® 2000 TPO membrane available from Dow Roofing Systems of Holyoke Mass. Other examples include products from Carlisle SynTec of Carlisle, Pa., Firestone Building Products of Indianapolis, Ind., GAF Materials Corporation of Wayne, N.J., Johns Manville of Denver, Colo., and others. TPO membranes are made of thermoplastic polyolefin elastomers, which are part of a family of rubberlike materials that are designed for strength, weatherability, fire and chemical resistance and durability. In the case of roofing applications, TPO offers resistance to ozone and ultra-violet light, is highly resistant to tears, impacts and punctures and exhibits good flexibility to allow for building movement and has been found to be excellent for low-slope conventional roofing applications. These materials are designed to combine the durability of rubber with the proven performance of hot air weldable seems. These materials offer excellent resistance to algae, are environmentally friendly and safe to install. In addition, TPO membranes can be reprocessed and recycled like other thermoplastic materials.

TPO membranes for roofing applications may be a single layer or may be composed of multiple layers and may contain a reinforcing fabric or scrim reinforcement material in the center between two layers of TPO. Some TPO membranes have fleece attached to the bonding side when used with water-based adhesives or hot asphalt adhesives. TPO membranes are installed either fully adhered, mechanically attached or ballasted. Fully adhered means that the roofing membrane is “glued” to a substrate using a special adhesive. Although a fully adhered installation is the preferred (quickest, most economical and best wind resistance performance), because of the polymer construction or nature of the membrane, a special adhesive must be used which actually creates a chemical bond between the membrane and the substrate. The TPO membrane is typically referred to as non-polar. The newly developed water-based adhesives as well as low VOC adhesives are, however, polar and accordingly they will not adhere very well to the TPO membrane.

The special adhesives which have been developed for applications of bonding a TPO membrane to a substrate and which adhere well to the TPO membrane are unfortunately not environmentally friendly and are not very “green”. The special adhesives typically used to date and which bond well to the TPO membrane contain high levels of volatile organic compounds (VOC's) to dissolve the polymers and resins used to bond these membranes. These VOC's are primarily petroleum-derived solvents or compounds that have a high vapor pressure and low water solubility. The VOC's are released into the air upon evaporation and are photochemically reactive, thus adding to atmospheric ozone, smog and pollution.

Many VOCs are human-made chemicals that are used and produced in the manufacture of adhesives, paints, pharmaceuticals, and refrigerants. VOCs are typically industrial solvents, such as trichloroethylene; fuel oxygenates, such as methyl tert-butyl ether (MTBE); or by-products produced by chlorination in water treatment, such as chloroform. VOCs are often components of petroleum fuels, hydraulic fluids, paint thinners, and dry cleaning agents, and are common ground-water contaminants. Solvents that are typically used in traditional roofing contact adhesive include, but are not limited to: toluene, xylene, heptane, hexane, ethyl acetate and methyl ethyl ketone.

In recent years, there has been an increased effort by local, state and federal agencies to limit the amount of VOC's that are released into the atmosphere by commercial/industrial processes, including commercial roofing. As a result, restrictions on the total VOC content for roofing adhesives have become more common with many locales requiring a VOC content of less than or equal to 250 grams per liter (or 2.08 pounds per gallon). For reference, a typical bonding adhesive could contain up to 650 grams per liter VOC. Therefore, there are significant efforts in place to avoid the use of VOC's as much as possible.

Although adhesives containing zero or very low levels of VOC's are available, they typically do not bond very well to TPO roofing membranes due to the low polarity and low surface energy of these membranes. Due to the chemical composition of the TPO material, a low or no VOC containing adhesive which can adhere to the TPO material has not to date been developed. Additionally, the low VOC adhesives that have been developed and are commercially available have many drawbacks and/or limitations to their use compared to typical higher VOC adhesives in terms of ease of application, open time, drying speed and ultimate bond strength.

Accordingly, there is a need to provide a bonding system for installing fully adhered TPO roofing membranes that can meet the lower VOC requirements for the bonding adhesive without sacrificing efficiency or bond quality.

### SUMMARY

The invention features a TPO membrane having a bottom surface to which may be adhered a water based or low or no VOC containing adhesive, the TPO membrane including a top surface and a bottom surface. The TPO membrane comprises a tie layer disposed on the bottom surface of the TPO membrane, the tie layer including at least a bottom surface having at least some polar component, the tie layer bottom surface configured for adhering to a water based or low or no VOC containing adhesive.

In one embodiment, the tie layer is adhered onto an existing TPO membrane after the TPO membrane is manufactured while in another embodiment, the tie layer is co-extruded onto the TPO membrane as the TPO membrane is being manufactured. The tie layer may be an E-VA-MAH based layer, and wherein the polar components include Vinyl Acetate (VA) and Maleic Anhydride (MAH) components.

The tie layer may have a thickness of between 0.25-5 mils while the TPO membrane and the tie layer together may have a total thickness of between 45 to 80 mils.

The invention also features a method for producing a TPO membrane that can easily bond to a low or no VOC containing adhesive. The method includes providing on at least a base or lower surface of the TPO membrane a primer or tie layer having a polar or high surface energy component or element and which allows the TPO membrane to adhere to a substrate using a water based or a low or no VOC containing adhesive. In one embodiment, the tie layer is added to an existing TPO membrane while in another embodiment, the tie layer is co-extruded with the TPO at the time the TPO membrane is manufactured. In the preferred embodiment, the tie layer is an E-VA-MAH based layer.

It is important to note that the present invention is not intended to be limited to a membrane or method of using the membrane which must satisfy one or more of any stated or implied objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims and their legal equivalents.

### BRIEF DESCRIPTION OF THE DRAWINGS

These and other features and advantages of the present invention will be better understood by reading the following detailed description, taken together with the drawings wherein:

FIG. 1 is a cross-sectional schematic representation of a TPO membrane on which has been provided the adhesive interface layer according to the present invention.

### DETAILED DESCRIPTION OF THE PREFERRED EMBODIMENTS

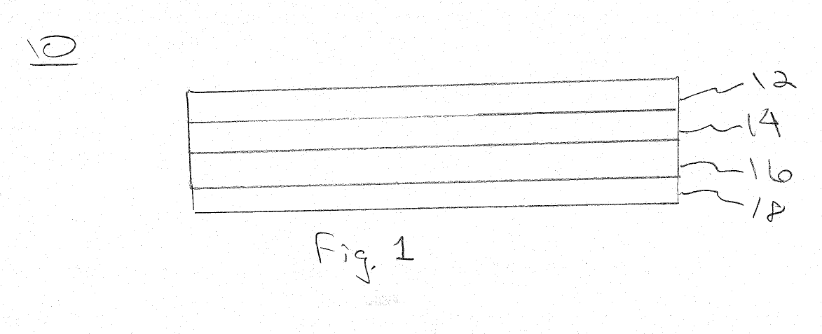

The present invention features a multilayered, TPO membrane 10, FIG. 1, comprising a top most TPO layer 12. The TPO top layer 12 may be bonded to an optional scrim reinforcement middle layer 14. The scrim reinforcement middle layer 14 is well known to those skilled in the art and is included in the Dow Tiempo product mentioned above. The optional scrim reinforcement middle layer 14, if provided, is bonded to a TPO bottom layer 16, which is then followed by a lower “tie” layer 18 which is the focus of the present invention.

The tie layer 18 in accordance with the present invention may be extruded onto an existing and previously manufactured TPO membrane 10 or alternatively, may be coextruded concurrently with the TPO membrane 10 at the time of initial manufacturing of the TPO membrane 10. The tie layer 18 is a thin layer, wherein the thickness is preferably between 0.25-5 mils (0.00025-0.005 inches). The proposed tie layer material may be ethylene-vinyl acetate or maleic anhydride grafted ethylene-vinyl acetate, or another suitable material.

The tie layer 18 serves as a “primer” layer for the bottom surface of the TPO membrane 10 which allows the TPO membrane to be adhered to an underlying substrate (not shown) using a compliant, low or no VOC containing adhesive or a water-based adhesive.

An example of a preferable tie layer material is Orevac® 9304 terpolymer available from Arkema Inc. having a North American headquarters in Philadelphia, Pa. Other suitable polymers for the tie layer material include Orevac® 9309, Orevac® 9314, Orevac® 9307Y, Orevac® 9318 and Orevac® 9305 all available from Arkema Inc. Other alternate polymers for the tie layer include Fusabond® C190 and Fusabond® C250 both from DuPont having a North American headquarters in Wilmington, Del.

Other suitable terpolymers or products having similar characteristics are considered to be within the scope of the invention. A terpolymer is a copolymer consisting of three distinct monomers. OREVAC® 9304 is a random terpolymer of Ethylene, Vinyl Acetate and Maleic anhydride in other words, a ethylene-vinyl acetate copolymer modified by adjunction of the polar compound Maleic anhydride. The Ethylene component is generally considered to be non-polar while the Vinyl Acetate component and the Maleic anhydride component are considered to be polar, resulting in a higher surface energy which makes it easier to bond to. Other similar polymers or terpolymers having at least one component that is generally “polar” as described above will also be known and readily discernible to those of ordinary skill in the art.

Examples of low or no VOC adhesives usable with the modified TPO membrane of the present invention include water based acrylic and polychloroprene latex bonding adhesives, solvent based polychloroprene contact adhesives dissolved in VOC-compliant solvents such as tertiary butyl acetate, acetone, or parachtorobenzotrifluoride and polyurethane moisture curing adhesives, all of which are presently known to those experienced in the commercial single-ply roofing membrane industry. A key feature of the present invention is not that a special adhesive is needed to adhere to the disclosed tie-layer, but that the tie-layer film is much easier to bond to than the TPO membrane, The use of the tie-laver disclosed herein allows commercially available VOC-compliant adhesives to bond more effectively to the tie-layer than they would to the un-modified TPO membrane.

In the preferred embodiment, the TPO membrane 10 including all of its layers, will be co-extruded at the time of initial manufacturing in a sheet form or alternatively, the tie layer 18 may be extruded onto an existing TPO membrane and laminated together. The process of extrusion and coextrusion is well known to those of ordinary skill in the art to which the invention pertains.

In the preferred embodiment, the entire membrane will vary in thickness from approximately 45 to 80 mils (0.045 to 0.080 inches). The top TPO layer 12 will range in thickness from approximately 15 to 20 mils while the bottom TPO layer is typically thicker than the top TPO layer. The tie layer 18 will be as thin as possible, preferably approximately 0.25-5 mils.

Accordingly, the method of co-extruding or otherwise providing a primer or tie layer 18 on the bottom of a TPO membrane serves to make the resultant TPO membrane easier to adhere to for a corresponding low or zero-VOC bonding adhesive, while providing all of the advantages of traditional un-modified TPO roofing membrane.

Modifications and substitutions by one of ordinary skill in the art are considered to be within the scope of the present invention, which is not to be limited except by the allowed claims and their legal equivalents.

The invention claimed is:

1. A method of providing a TPO membrane having a bottom surface to which may be adhered a water based or low or no VOC containing adhesive, the method comprising the acts of:
providing, on at least a bottom surface of said TPO membrane, a tie layer, said tie layer including at least a bottom surface having at least some polar component, said tie layer bottom surface configured for adhering to a water based or low or no VOC containing adhesive.

2. The method of claim 1 wherein said tie layer is adhered onto an existing TPO membrane after said TPO membrane is manufactured.

3. The method of claim 1 wherein said tie layer is co-extruded onto said TPO membrane as said TPO membrane is being manufactured.

4. The method of claim 1 wherein said tie layer is an E-VA-MAH based layer, and wherein said polar components include Vinyl Acetate (VA) and Maleic Anhydride (MAH) components.

5. The method of claim 1, wherein said tie layer has a thickness of between 0.25-5 mils.

6. The method of claim 1, wherein said TPO membrane and said tie layer have a total thickness of between 45 to 80 mils.

7. A TPO membrane having a bottom surface to which may be adhered a water based or low or no VOC containing adhesive, the TPO membrane including a top surface and a bottom surface, said TPO membrane comprising:
a tie layer disposed on said bottom surface of said TPO membrane, said tie layer including at least a bottom surface having at least some polar component, said tie layer bottom surface configured for adhering to a water based or low or no VOC containing adhesive.

8. The TPO membrane of claim 7 wherein said tie layer is adhered onto an existing TPO membrane after said TPO membrane is manufactured.

9. The TPO membrane of claim 7 wherein said tie layer is co-extruded onto said TPO membrane as said TPO membrane is being manufactured.

10. The TPO membrane of claim 7 wherein said tie layer is an E-VA-MAH based layer, and wherein said polar components include Vinyl Acetate (VA) and Maleic Anhydride (MAH) components.

11. The TPO membrane of claim 7, wherein said tie layer has a thickness of between 0.25-5 mils.

12. The TPO membrane of claim 7, wherein said TPO membrane and said tie layer have a total thickness of between 45 to 80 mils.

13. A TPO membrane having a bottom surface to which may be adhered a water based or low or no VOC containing adhesive, the TPO membrane including a top surface and a bottom surface, said TPO membrane comprising:
a tie layer disposed on said bottom surface of said TPO membrane, said tie layer including at least a bottom surface having at least some polar component, said tie layer bottom surface configured for adhering to a water based or low or no VOC containing adhesive, wherein said tie layer is co-extruded onto said TPO membrane as said TPO membrane is being manufactured and wherein said tie layer is an E-VA-MAH based layer, and wherein said at least some polar component include Vinyl Acetate (VA) and Maleic Anhydride (MAH) components.
